(19) United States
(12) Patent Application Publication
(10) Pub. No.: US 2025/0296379 A1
(43) Pub. Date: Sep. 25, 2025

(54) METHOD FOR MANUFACTURING A DECORATIVE SHEET AND A DECORATIVE SHEET

(71) Applicant: Unilin, BV, Wielsbeke (BE)

(72) Inventors: Benjamin CLEMENT, Wielsbeke (BE); Michiel BLIEK, Wielsbeke (BE)

(73) Assignee: Unilin, BV, Wielsbeke (BE)

(21) Appl. No.: 19/083,223

(22) Filed: Mar. 18, 2025

(30) Foreign Application Priority Data
Mar. 20, 2024 (EP) 24164759.3

(51) Int. Cl. B41M 5/00

(52) U.S. Cl. CPC B41M 5/0023; B41M 5/0047; B41M 5/0064

(57) ABSTRACT

A method for manufacturing a decorative sheet for making decorative panels may involve providing a sheet, preferably a paper layer or a thermoplastic foil. A printed motif may be applied to the sheet by means of digital printing. The printed motif may be applied using a pigmented ink. The pigmented ink may have a viscosity above 30 mPa·s, preferably above 40 mPa·s. Decorative sheets may be obtained by the method. A method may be provided for manufacturing a decorative panel that includes the decorative sheet.

This application claims priority under 35 USC 119(a)-(d) from EP patent application No. 24164759.3 filed Mar. 20, 2024, the entire contents of which are incorporated herein by reference.

### BACKGROUND

### 1. Field

The present invention relates to the manufacturing of a decorative sheet, such as a decorative paper layer or a decorative thermoplastic foil. In particular, the present invention further relates to decorative sheets suitable for being used in the fabrication of decorative panels, for example floor panels, wall panels, ceiling panels or furniture panels. A further object of the invention is a method for manufacturing said decorative panel.

The invention relates to decorative panels of the type at least comprising a substrate material and a provided thereon top layer with a printed décor. Examples of such decorative panels object of the invention are laminate panels, LVT panels (Luxury Vinyl Tile), SPC panels (Stone Plastic Composite), WPC panels (Wood Plastic Composite), cement-based panels and mineral-based panels, for example MgO panels.

### 2. Discussion of Related Art

In laminate panels, the substrate preferably is wood-based, such as an MDF or HDF substrate (Medium or High Density Fiberboard) or a substrate consisting of or essentially made of wood particleboard. The top layer is preferably formed from thermosetting resin and comprises one or more paper layers, wherein said paper layers at least comprise a decorative paper sheet formed by a décor paper having said printed décor on its top surface. Said decorative paper is impregnated with a thermosetting resin, for example a melamine resin, in order to obtain lamination with the substrate in a subsequent pressing operation. It is a standard procedure to apply the printed motif to the décor paper by means of analog printing, such as rotogravure or offset printing, which has the drawbacks of having large minimal order quantities and a limited freedom of the printed motif, which results in repetitions. In order to overcome these limitations, digital printing, such as digital inkjet printing, is a new trend.

However, inkjet printing has the drawback that the inks involved are more prone to bleeding during resin impregnation than inks used in analog printing. In order to reduce bleeding of the printed motif, typically one or more ink receiver layers are applied to the paper layer before applying the printed motif thereon. Such ink receiver layers, however, tend to cause issues for the subsequent lamination of the décor paper to the substrate, and are also known to release dust which causes clogging of the nozzles of the digital printer.

In the case of decorative panels whose substrate is not predominantly wood-based, such as for example LVT, SPC, WPC, cement-based, or mineral-based panels such as MgO panels, the top layer comprises at least one decorative sheet formed by a thermoplastic foil, for example a polyvinyl chloride (PVC) foil, having the decorative pattern. As the vehicle of the ink droplets cannot penetrate into the thermoplastic foil, direct printing on said thermoplastic foil causes the droplets to spread laterally, which results in a reduced resolution of the printed motif. This is usually improved by applying one or more ink receiver layers, however, this on its turn leads to similar issues for subsequent lamination and clogging of the printer nozzles as described above.

With respect to the above background information, reference is made to the documents EP 1 290 290, EP 1 872 959, EP 2 132 041, EP 1 044 822, WO 2015/118451, U.S. Pat. No. 11,802,215 and US 2023/0234339.

### SUMMARY

The present invention aims in the first place at an alternative method for manufacturing a decorative sheet to be used in decorative panels, and seeks, in accordance with several of its preferred embodiments, to solve one or more of the problems arising in the state of the art. Further objectives of the present invention are a said decorative sheet to be used in decorative panels, and an alternative method for manufacturing said decorative panels. The essential features of the invention are described in the independent claims whereas preferred embodiments of the invention are detailed in the dependent claims.

In accordance with its first independent aspect, the invention relates to a method for manufacturing a decorative sheet, wherein the method comprises at least the steps of
providing a printable sheet,
applying a printed motif to the sheet by means of digital printing,
   wherein the printed motif is applied using a pigmented ink,
   wherein the pigmented ink has a viscosity above 30 mPas, preferably above 40 mPas.

Within the context of the present invention, for the viscosity it is meant the dynamic viscosity in a viscosimeter, preferably a dynamic viscosimeter, measured at 32° C. with a shear rate of 1000 s−1.

Typical pigmented inks according to the state of the art, for example in U.S. Pat. No. 11,802,215, have a low viscosity e.g. below 10 mPas. However, by private research, the inventor has found that digital printing, and especially digital inkjet printing, of a pigmented ink that has a high viscosity such as a viscosity above 30 mPas, preferably above 40 mPas, provides a better printing quality than when printing using low viscosity pigmented inks. In addition, the inventors have surprisingly found that high viscosity inks lead to reduced need of ink receiver layer on the printable sheet thereby improving subsequent processing of the decorative sheet in the manufacturing of decorative panels.

Pigmented inks are normally formed by a solid portion, comprising at least one pigment, and a liquid or fluid portion, comprising at least a vehicle, in which the solid portion is dispersed. The viscosity of the pigmented ink can be increased by increasing the content of the solid portion or by decreasing the content of the fluid content. In particular, the viscosity of pigmented inks can be increased by increasing the pigment content (part of the solid portion), for example, the pigment portion of the ink can represent at least the 3% weight of the ink, more preferably more than the 5% weight of the ink. In case the ink comprises a binder, this can be part of the above-mentioned solid content, so that the viscosity can be increased by increasing the ink of the binder. The solid portion of the ink can represent at least 5% of the ink, more preferably more than 10% weight of the ink.

When printing onto printable sheets which are adapted to absorb the vehicle of the ink, for example a porous printable sheet like a paper sheet, the feature of the can lead to a synergistic beneficial effect that the risk of sheet wrinkles due to an excess of vehicle absorption in the printable sheet is reduced, which further has the advantage that less energy is required to dry the pigmented ink. Additionally, high viscosity inks penetrate less deep into the absorbing printable sheet and spread less laterally, which results in a higher optical density and a better resolution of the printed motif. Similarly, for printable sheets not capable of absorbing the ink, for example non-porous sheets like thermoplastic foils, high viscosity inks spread less laterally and thus provide for a higher resolution of the printed motif. As a result, in order to obtain a similar printing result as with low viscosity inks, the high viscosity inks can be applied with a significantly reduced laydown, providing a reduction of the cost of the printing materials. Preferably said pigments of said pigmented ink have an average particle size of less than 250 nanometer. The average particle size of the pigments in the pigmented ink are preferably between 50 and 300 nm, more preferably between 80 and 200 nm, most preferably between 100 and 150 nm. Below an average particle size of 50 nm, a reduction is often observed in light fastness. Above an average particle size of 300 nm, the color gamut is usually reduced.

Preferably, the dry weight of the total volume of the high viscosity pigmented ink printed on the sheet is less than 5 g/m2 dry weight, even more preferably less than 2 g/m2. The limitation of the dry weight of the applied ink leads to a layer of ink that lowers the risk of pressing defects and splitting in the top layer. Indeed, possible interference between the ink layer and the thermosetting resin during the pressing operation is limited. Preferably the printed motif is entirely, or at least essentially, made up of such pigmented ink, wherein the printed motif covers the majority, and preferably 80 percent or more of the surface of said paper layer. Preferably said total volume of deposited pigmented ink is less than 20 milliliters per square meter, or even better less than 15 milliliters per square meter or still less, e.g. 10 milliliters per square meter or less

According to the most preferred embodiment, the vehicle of the pigmented ink is water-based, in other words the pigmented ink is water-based or aqueous. Water-based inks are more economical than UV curable inks, and form a lesser problem regarding compatibility with thermosetting resins, such as melamine resin. According to less preferred alternatives, the vehicle is a non-aqueous vehicle. For example, the ink could be solvent based, oil based or hydro-UV based.

Preferably, for the pigmented ink use is made of organic pigments. It is, however, not excluded according to the present invention that use is made of inorganic pigments, or even a combination of both organic and inorganic pigments.

Preferably the pigmented inks comprise between 3 and 6 or even up to 8 different colors. More than just the at least 3 base colors, e.g. more colors than Cyan, Magenta, Yellow and possibly black (CMYK), may lead to a lower need of deposited ink. One or more dedicated colors, whether or not supplementing the inks of the CMYK colors, might be used, such that these colors must not necessarily be formed by color addition of the several base colors, but can be created by jetting the dedicated color only. In the case of wood patterns, a brownish dedicated color might be used, thereby tremendously lowering the needed dry weight of deposited inks for the typical colors of wood patterns.

Preferably, the pigmented ink comprises a dispersant, preferably a polymeric dispersant. In a preferred embodiment, the aqueous pigmented inks comprise a self-dispersible color pigment, which no longer requires said dispersant because the pigment surface has ionic groups which realize electrostatic stabilization of the pigment dispersion. In this case, the use of a dispersant, such as a polymeric dispersant, is optional.

Preferably, the pigmented ink comprises a surfactant. Preferably, the aqueous pigmented ink comprises a humectant.

The advantage of digital printers is their enhanced flexibility, providing the freedom to design and print high quality patterns without repetitions. Preferably, the digital inkjet printer is of the single-pass type, or is operated in the single-pass mode. This has the benefit that high printing speeds, desirable for industrial applications, can be attained. Alternatively, it is also possible to use a multi-pass digital inkjet printer, which has the advantage that the signature of possibly defective printer nozzles, e.g. clogged printer nozzles, can be negated in a successive printing pass.

According to the most preferred embodiment, use is made of a drop-on-demand inkjet printer, wherein only the desired ink droplets are fired or jetted from the nozzles of the printheads. It is however not excluded that use would be made of a continuous inkjet printer, wherein ink droplets are continuously fired from the nozzles of the printheads, but wherein the undesired droplets are carried away and do not reach the paper layer to be printed. Preferably, for printing the decorative sheet of the invention, a digital inkjet printer is applied that allows to jet ink droplets with a volume of less than 50 picoliters. The inventors have found that working with droplets having a volume of 15 picoliters or less, for example of 10 picoliters, brings considerable advantages regarding the limitation of dry weight of deposited inks. Preferably a digital inkjet printer is applied that allows to work with ink droplets of several volumes in one and the same print, or with so-called halftone or gray scale. The possibility of half tone or gray scale printing enables further limitation of the dry weight of the deposited ink while maintaining an excellent print definition. Preferably, a digital inkjet printer is applied that allows to attain a definition of at least 200 dpi, more preferably at least 300 dpi, even more preferably at least 600 dpi (dots per inch).

A suitable digital inkjet printhead capable of jetting inkjet droplets of high viscosity is the Xaar Aquinox. According to alternative embodiments, other digital printing methods such as for example laser printing are used

According to the first main embodiment of the invention, said printable sheet is a paper layer. The method of the invention is particularly advantageous when it is started from a paper layer, the mean air resistance of which is low, e.g. with a Gurley value, measured according to Tappi 460, of 30 seconds or below, more preferably of 25 seconds or below. This facilitates the impregnation of the printed paper layer in a subsequent step for the manufacturing of decorative panels.

Preferably, the paper layer has a base weight of 50 to 100 grams per square meter, e.g. between 60 and 80 grams per square meter.

The paper layer may be a white, colored, pigmented and/or dyed base paper. The use of a colored and/or dyed base paper enables further limiting the dry weight of the deposited ink for attaining a particular pattern or color. Preferably the dye or pigment is added to the pulp before the paper sheet is formed.

According to the most preferred embodiment, the paper layer is free of an ink receiver layer. This has the benefit that the problem of dust creation known from the ink receiver layers in the state of the art is overcome. Furthermore, a better impregnation of the printed paper layer, for use as decorative paper layer, can be obtained. Additionally, this also makes for a more efficient manufacturing process, since at least the step of applying one or more ink receiver layers has been removed with an immediate subsequent reduction of cost and the deletion of printing defects due to inhomogeneity in the application of the ink receiver layer. It is, however, not excluded within the scope of the present invention that, according to a less preferred embodiment, one or more ink receiver layers are applied to the paper layer before applying the digital print. In the case that an ink receiver layer is applied, it is preferable that it shows a laydown with a dry weight of less than 10 g/m2, preferably less than 5 g/m2, more preferably less than 3 g/m2, The ink receiver layer can help reducing the quantity of the ink to be delivered onto the printable substrate.

In the embodiments wherein the paper layer comprises one or more ink receiver layers, the ink receiver layer preferably comprises at least a binder and/or a pigment.

According to the most preferred embodiment, for the binder in said ink receiver layer at least or mainly polyvinyl alcohols are used. According to variants, the ink receiver layer includes, as a binder, a polymer selected from the group consisting of hydroxyethyl cellulose; hydroxypropyl cellulose; hydroxyethylmethyl cellulose; hydroxypropyl methyl cellulose; hydroxybutylmethyl cellulose; methyl cellulose; sodium carboxymethyl cellulose; sodium carboxymethylhydroxethyl cellulose; water soluble ethylhydroxyethyl cellulose; cellulose sulfate; vinylalcohol copolymers; polyvinyl acetate; polyvinyl acetal; polyvinyl pyrrolidone; polyacrylamide; acrylamide/acrylic acid copolymer; polystyrene, styrene copolymers; acrylic or methacrylic polymers; styrene/acrylic copolymers; ethylene-vinylacetate copolymer; vinyl-methyl ether/maleic acid copolymer; poly(2-acrylamido-2-methyl propane sulfonic acid); poly(diethylene triamine-co-adipic acid); polyvinyl pyridine; polyvinyl imidazole; polyethylene imine epichlorohydrin modified; polyethylene imine ethoxylated; ether bond-containing polymers such as polyethylene oxide (PEO), polypropylene oxide (PPO), polyethylene glycol (PEG) and polyvinyl ether (PVE); polyurethane; melamine resins; gelatin; carrageenan; dextran; gum arabic; casein; pectin; albumin; chitins; chitosans; starch; collagen derivatives; collodion and agar-agar. The most preferred variants for the binder are polyvinyl acetates, ethylvinylacetates, block copolymers based on polyvinylacetate, block copolymers based on polyvinylalcohol, acrylates, latexes, polyvinyl derivaties, VCVAC derivatives, polyurethanes based on polyols and isocyanates, polyurethanes based on polycarbamates and polyaldehydes, e.g. both as a watery dispersion/emulsion or a watery or solvent solution.As stated above preferred binders for the ink receiver layer include polyvinyl alcohol (PVA), but according to variants a vinylalcohol copolymer or modified polyvinyl alcohol may be applied. The modified polyvinyl alcohol may be a cationic type polyvinyl alcohol, such as the cationic polyvinyl alcohol grades from Kuraray, such as POVAL C506, POVAL C118 from Nippon Goshei. Preferably, said printable substrate is provided with 0.2 to 7 g/m², and preferably between 0.5 and 5 g/m², dry coating weight of a binder in said ink receiver layer.

In case the sheet comprises an ink receiver layer, it is preferred that the ink receiver layer is pigment free. The inventor has found that by limiting the quantity of pigment in the ink receiver layer it is possible to improve subsequent lamination of the decorative paper layer, and to reduce or eliminate dust release from the inkjet receiver layer itself. In addition, in view of the lack of pigment it is possible to reduce the amount of binder in the ink receiver layer itself thereby. As a consequence, it is easier to minimize the amount of ink receiver layer on the sheet when the ink receiver layer is free from pigments.

In case the ink receiver layer comprises pigments, it is preferred that at least or mainly silica particles are used. Alternatively, for the pigment of said ink receiver layer at least or mainly particles are used chosen from the list consisting of calcium carbonate, alumina, aluminosilicates, ordered mesoporous materials, modified silica, organosilica, modified organosilica, organoalumina, modified alumina, aluminates, modified aluminates, organoaluminates, modified organoaluminates, zeolites, metal organic frameworks and porous polar polymers. Preferably, said ink receiver layer has, globally seen, a pigment to binder ratio between 0/1 or 0.01/1 and 25/1, preferably between 0/1 or 0.01/1 and 20 Preferably said pigment has a BET surface area between 10 and 1600 m²/g, and preferably between 15 and 500 m²/g.

The ink receiver layer can also comprise a flocculant, preferably a metal salt, preferably a cationic metal salt. Preferably said metal salt is chosen from the list consisting of CaCl2, MgCl2, CaBr2, MgBr2, CMA (Calcium Magnesium Acetate), NH4Cl, Calcium Acetate, ZrCl4, calcium nitrate and Magnesium Acetate. The positive ion of the dissolved metal salt will tend to neutralize the electrosteric stabilization function of the pigment contained in the ink thereby improving its absorption. The most preferred cationic metal salts are CaCl2, MgCl2, CMA, Calcium Acetate, calcium nitrate and Magnesium Acetate, as the inventors have obtained the best results with these ink reactive compounds. Said flocculant can also be chosen from the list consisting of sodiumaluminate, a double sulphate salt such as alum, polyaluminumchloride, polyacrylate, dicyandiamide (e.g. Floquat DI5 from SNF) and polyacrylamide. The flocculating agent pulls the ink pigments out of the ink dispersion. Thereby the pigments are prevented from penetration too far down into the ink receiver layer. Mainly the vehicle of the ink, e.g. the water in the case of water-based inks, is absorbed deeper down into the ink receiver layer. Preferably, the optional ink receiver layer is provided with 20 to 60%, based on dry coating weight of flocculating agent, in particular of metal salt.

The ink receiver layer can further comprise a crosslinking agent. Preferably, the ink receiver layer can comprise a content of crosslinking agent below 5% based on dry weight of the composition. The crosslinking agent can be preferably selected from the group comprising: aldehydes, polyaldehydes, dialdehydes, alcohols, boronic acid, borax, polyalcohols, carbamates, polycarbamates, carbonic acids, glyoxal based agent, zirconium-based agents, titanates and polycarbonic acids. The ink receiver layer can further comprise a dispersant. A dispersant is an oligomer or polymer which stabilizes the liquid dispersions of pigment contained in the ink against flocculation. The dispersant can comprise polycarboxylates, polyphosphates, a polyionic polymer, preferably polyDADMAC (Polydiallyldimethylammonium chloride) polyamine or alumina salts. Preferably, the ink receiver layer is provided with less than 10%, more preferably less than 5%, based on dry coating weight of dispersant, for example between 5 and 0%. Preferably, said ink receiver layer has, globally seen, a pigment to dispersant ratio between 10/1 and 100/1.

It is not excluded that the ink receiver layer is non uniform and shows layerwise or areawise differences in composition, in which case the above values are average values for the totality of the inkjet receiver layer.

The optional ink receiver layer may also comprise one or more of the following agents:
Agents altering, more particularly lowering, the pH of said ink receiver layer. Preferably the pH of the ink receiver layer composition is lowered to pH 6 or lower, by selecting the amount and type of said agent, which selection is within the ambit of the skilled man. Preferably said agent is chosen from the list consisting of formic acid, tartaric acid, acetic acid, hydrochloric acid, citric acid, phosphoric acid, sulfuric acid, AlCl3 and boronic acid. An adjusted, more particularly lowered pH, preferably to pH 6 or less, increases the chemical affinity of the inkjet receiver layer with the ink and will interfere with the electrosteric stabilization function on the pigment, such that the dispersion of the pigments in the ink will become destabilized quickly.
Particle surface modifying agents or coupling agents: between 0.05 and 5 g/m², preferably between 0.2 and 2 g/m², e.g. chosen from the non-limiting list consisting of amino silanes, ureido silanes, aldehyde silanes, tetraethylorthosilicate, siliazanes, organically modified silanes, organically modified siliazanes, chlorosilanes, organically modified chlorosilanes, bissilanes, organobissilanes, silsesquioxanes, polysilsesquioxnes, silane oligomers, organically modified silane oligomers, bissilane oligomers, organically modified bissilane oligomers, oligomeric silsesquioxanes, and oligomeric polysilsesquioxanes.
Additives: wetting agent between 0.005 and 1 g/m², preferably between 0.05 and 0.5 g/m²; and/or defoaming agent between 0.005 and 1 g/m², preferably between 0.05 and 0.5 g/m²; and/or fungicide between 0.005 and 1 g/m², preferably between 0.05 and 0.5 g/m².

According to a second main embodiment of the invention, said aforementioned sheet is a thermoplastic foil. The thermoplastic material for forming the foil is preferably chosen from the list of polyvinyl chloride (PVC), polyethylene (PE), polypropylene (PP), polyethylene terephthalate (PET), thermoplastic polyurethane (TPU), polyvinyl butyral (PVB).

The preferred specifications regarding the optional ink receiver layer, the pigmented ink and the digital printer for the second main embodiment are interchangeable with the specifications as described before for the first main embodiment. Nevertheless, it is noted that in said second main embodiment the binder of the ink receiver layer can be polyurethane or acrylic based, for example comprise a water-based polyurethane dispersion, vinyl based or acrylic based.

Digital printing, is difficult on thermoplastic foils because of the impermeability of thermoplastic foils. Therefore, the vehicle of the ink cannot penetrate into the thermoplastic foil, which causes lateral spreading of the ink droplets and leads to a reduced quality of the printed motif. High-viscosity pigmented inks according to the invention have a lower vehicle content or an increased pigment and/or binder content which significantly reduces this problem, and thus provide an increased printing quality. In particular, in view of the reduced amount of ink it is possible to speed up the drying of the ink itself thereby immediately fixing the pigment on the desired position. Additionally, the lower vehicle content provides the additional benefit that less heating energy needs to be supplied in order to dry the applied ink. Especially for thermoplastic foils, which are known to be highly sensitive to temperature, a reduction of the required heating energy for drying is beneficial.

The thermoplastic foil may be foamed or not foamed. The thermoplastic foil may comprise fillers. Said fillers may comprise organic fillers such as for example wood fibers or wood chips and/or inorganic filles such as chalk, limestone or other CaCO3 fillers. The thermoplastic foil may comprise plasticizers. In a preferred embodiment, the thermoplastic foil substantially consists of rigid PVC, wherein rigid PVC comprises less than 5 wt % plasticizer.

According to a preferred embodiment, the method of the invention is of the roll-to-roll type. Preferably, the method starts with a sheet, preferably a standard or unprocessed sheet, from a roll. In a subsequent step, the sheet is provided with a decorative motif by means of a digital inkjet printer depositing high-viscosity pigmented ink droplets. Most preferably, the sheet is free of an ink receiver layer before the printing. After applying the printed motif, the decorative sheet is passed through a drying equipment, for example a hot air dryer or an infrared radiation dryer. Finally, the decorative sheet is rolled onto a roll, where it is ready to be used in any desired further process.

According to all above embodiments, it is possible that the sheet onto which a printed motif is applied, is a sheet with a basic color. A sheet with a basic color can be obtained by including pigments and/or dyes into the mixture when forming the sheet. Using a sheet with a basic color has the advantage that the laydown of the pigmented ink can be significantly reduced, since only areas deviating from said basic color need to be provided of said printed motif.

It is clear that the present invention also relates to decorative sheets that are obtained using the methods of the first independent aspect of the present invention.

Therefore, according to a second independent aspect, the invention also relates to a decorative sheet, wherein said decorative sheet is provided with a digitally printed motif, wherein the printed motif is applied using a pigmented ink, wherein the viscosity of the pigmented ink is above 30 mPa·s, preferably above 40 mPa·s.

Such a decorative sheet may be obtained using the method of the first independent aspect of the invention, though not necessarily. It is clear that such decorative sheet may further show one or more of the features inherent to decorative sheets obtained using the method of the first independent aspect.

The invention further, in accordance with its third independent aspect, relates to a method for manufacturing a decorative panel, wherein the decorative panel at least comprises a substrate material and a provided thereon top layer with a printed décor, wherein said top layer at least comprises a decorative sheet obtained in accordance with the first and second independent aspects or the embodiments thereof, and wherein the substrate is connected to the decorative sheet.

According to a first possibility for manufacturing said panel, the decorative panel is a laminate panel, wherein the substrate is preferably wood-based, and the top layer comprises one or more paper layers comprising at least a decorative sheet, according to the second independent aspect and/or manufactured in a method according to the first independent aspect, which is made of paper.

In this first possibility, said decorative sheet is impregnated with a thermosetting resin. Preferably said decorative sheet is provided with an amount of thermosetting resin equaling 40 to 250% dry weight of resin as compared to the weight of the paper. Experiments have shown that this range of applied resin provides for a sufficient impregnation of the paper, that this avoids splitting to a large extent, and that this stabilizes the dimension of the paper to a high degree. Preferably, the amount of thermosetting resin is such that at least the paper core is satisfied with the resin. Such satisfaction can be reached when an amount of resin is provided that corresponds to at least 1.5 or at least 2 times the paper weight. It should be clear that the resin which is provided on the paper layer is not necessarily only available in the core of the paper, but may form surface layers on both flat sides of the paper.

Preferably the step of providing said decorative sheet with thermosetting resin involves applying a mixture of water and the resin on said decorative sheet. The application of said mixture might involve immersion of the decorative sheet in a bath of said mixture and/or spraying, jetting or otherwise coating said mixture on said decorative sheet. Preferably the resin is provided in a dosed manner, for example by using one or more squeezing rollers and/or doctor blades to set the amount of resin added to the decorative sheet.

Preferably said thermosetting resin is a melamine based resin, more particularly a melamine formaldehyde resin with a formaldehyde to melamine ratio of 1.4 to 2. Such melamine based resin is a resin that polycondensates while exposed to heat in a pressing operation. The polycondensation reaction creates water as a by-product. It is particularly with these kinds of thermosetting resins, namely those creating water as a by-product, that the present invention is of interest. The created water, as well as any water residue in the thermosetting resin before the pressing, must leave the hardening resin layer to a large extent before being trapped and leading to a loss of transparency in the hardened layer. It is thus beneficial, in accordance with the present invention, that the high viscosity pigmented ink allows for a very small laydown of ink receiver layer or even for the absence of an ink receiver layer, which allows the polycondensation water to evacuate more easily. Other examples of such thermosetting resins leading to a similar polycondensation reaction include ureum-formaldehyde based resins and phenol-formaldehyde based resins or acrylic or polyurethane resins.

The impregnation may be performed in a two-step process as known from US 2023/0234339.

As is clear from the above, the method of the first possibility in accordance with the third independent aspect of the invention preferably comprises the step of hot pressing the resin provided decorative sheet on the substrate, at least to cure the resin and fix the decorative sheet on the substrate. Preferably the method of the invention forms part of a DPL (Direct Pressure Laminate) process, wherein the resin provided decorative sheet of the invention is taken up in a stack to be pressed as the decorative layer on a substrate. It is of course not excluded that the method of the invention would form part of a CPL (Compact Laminate) or an HPL (High Pressure Laminate) process in which the decorative layer is hot pressed at least with a plurality of resin impregnated core paper layers, e.g. of so called Kraft paper, forming a substrate underneath the decorative layer, and wherein the obtained pressed and cured laminate layer, or laminate board is, in the case of an HPL, glued to a further substrate, such as to a particle board or an MDF or HDF board. Alternatively, the further substrate may be a gypsum board or a cement board. According to yet another alternative, the further substrate may be an MgO board or may be a board comprising MgO.

Preferably, the top layer of the panel comprises a wear layer above said printed décor. Preferably, said wear layer is in the form of a further resin layer comprising thermosetting resin is applied above the printed motif, e.g. by way of an overlay, i.e. a resin provided carrier layer or a liquid coating, preferably while the decorative sheet is laying on the substrate, either loosely or already connected or adhered thereto. Preferably, the further resin layer is transparent or translucent, so that the printed motif underneath remains visible. The further resin layer enhances the wear resistance of the decorative panel.

Preferably, the wear layer comprises hard particles, such as aluminiumoxide or corundum particles. Hard particles having an average particle size of between 1 and 200 micrometer are preferred. Preferably an amount of such hard particles of between 1 and 40 grams per square meter is applied in the further resin layer. An amount lower than 20 grams per square meter can suffice for the lower qualities.

According to a special embodiment, said wear layer is a layer of colored thermosetting resin. For example use can be made of a colored or pigmented overlay, wherein the colored resin is provided on a paper layer. The use of a colored resin enables further limiting the dry weight of the deposited ink for attaining a particular motif. According to a variant, the paper layer of the overlay is colored in that it is provided with a print itself, preferably at the side thereof that is or will be directed to the substrate. Such print may also be a digital inkjet print by means of pigment containing inks and/or might be obtained by means of a method in accordance with of the invention.

Preferably the method of the invention further comprises the step of applying a counter layer or balancing layer at the surface of the substrate opposite the decorative sheet. The counter layer or balancing layer preferably comprises a paper layer and thermosetting resin, preferably the same resin as the top layer.

Preferably the mutual adherence of the plate-shaped substrate, the possible counter layer, the decorative paper layer and the possible transparent or translucent layer is obtained in one and the same press treatment. According to the most preferred embodiment, the steps of the method of the invention are taken up in a DPL process.

According to a preferred embodiment, a stack is formed of a resin provided counter layer, a plate-shaped substrate, the resin provided decorative sheet and the wear layer. The stack is then pressed at a temperature between 150 and 250° C. and at a pressure of more than 10 bar, preferably more than 20 bar. While pressing, the surface of the stack contacts a structured press element, such as a structured press plate, and a relief is formed in the top layer of the obtained decorative panel. Possibly, the obtained relief reaches into the plate-shaped substrate. Possibly, and preferably, the obtained relief is formed in register with the printed motif of the resin provided paper layer. The latter is possible in all embodiments of the present invention.

According to a second possibility for manufacturing the decorative panel, the decorative panel is of the kind that its substrate is not predominantly wood-based, such as for example LVT, SPC, WPC, cement-based, or mineral-based panels such as MgO panels, and wherein the top layer comprises a decorative sheet in the form of a thermoplastic foil. Preferably, the substrate is a thermoplastic substrate or is substantially made of thermoplastic material. The thermoplastic material of the substrate is then preferably selected from the list of polyvinyl chloride (PVC), polyethylene (PE), polypropylene (PP), polyethylene terephthalate (PET), thermoplastic polyurethane (TPU), polyvinyl butyral (PVB). The thermoplastic substrate may be foamed or not foamed. The thermoplastic substrate may comprise fillers. Said fillers may comprise organic fillers such as for example wood fibers or wood chips and/or inorganic filles such as for example chalk, limestone or other CaCO3 fillers. The thermoplastic substrate may comprise plasticizers. In a preferred embodiment of this second possibility, the thermoplastic substrate substantially consists of rigid PVC, wherein rigid PVC comprises less than 5 wt % plasticizer.

Preferably, an overprint varnish ca be applied above the digital print in order to further enhance the quality of the printed motif.

In the method of the second possibility, a thermoplastic material based wear layer is placed above the printed thermoplastic foil. Preferably, the thermoplastic material in the wear layer can be selected from the same list as the thermoplastic material in the thermoplastic substrate. Most preferably, the wear layer can be a PVC wear layer. The wear layer may comprise hard particles, such as the hard particles in accordance with the hard particles described above in the first possibility, in order to improve the wear resistance of the decorative panel. Optionally, the wear layer comprises pigments, which can reduce the amount of required pigment in the print.

Preferably, the decorative panel of the second possibility can comprise a counter layer, preferably of the same thermoplastic material forming the decorative sheet, on the side of the substrate opposite the decorative thermoplastic layer. The counter layer may provide the decorative panel with additional stability as well as enhanced acoustic properties.

According to a preferred embodiment of this second possibility, a stack is made comprising the optional counter layer, the substrate, the decorative thermoplastic foil, the optional overprint varnish, and the thermoplastic wear layer. Similar as for the first possibility, the stack is pressed in order to obtain a decorative panel. Preferably, while pressing, the surface of the stack contacts a structured press element, such as a structured press plate, and a relief is formed in the top layer of the obtained laminate panel. Possibly, the obtained relief reaches into the plate-shaped substrate. Possibly, and preferably, the obtained relief is formed in register with the printed motif of the resin provided paper layer. The latter is possible in all embodiments of the present invention.

According to all embodiments, the decorative panels according to the third independent aspect may optionally comprise a lacquer layer, preferably a thermally curable or UV-curable lacquer layer.

It is clear that the decorative sheet, substrate or decorative panel mentioned above may have to be divided during the methods of the invention for obtaining their respective final dimensions. Other treatments of the obtained panels are of course not excluded.

Considering that the state of the art typically employs ink sets with low viscosity, typically limited to about 10 mPa·s, the high viscosity ink sets used in the present invention for the manufacturing of decorative sheets and/or decorative panels entails a novel and inventive concept. Therefore, in accordance with its fourth independent aspect, the invention relates to high viscosity ink sets suitable for the manufacturing of decorative sheets and/or decorative panels, characterized in that the inks are pigmented inks having a viscosity above 30 mPa·s, preferably above 40 mPa·s.

Within the context of the present invention, for the viscosity it is meant the dynamic viscosity in a viscosimeter, preferably a dynamic viscosimeter, measured at 32° C. with a shear rate of 1000 s−1. The decorative sheets may relate to the decorative sheets obtained in the first independent aspect, although this is not necessary. The decorative panels may relate to the decorative panels obtained in the third independent aspect, although this is not necessary. The high viscosity ink sets may relate to the high viscosity pigmented aqueous ink used in the above independent aspects of the invention, although this is not necessary.

The high viscosity inkjet ink sets at least comprise pigments and a vehicle wherein the pigments are dispersed, thus being a pigment dispersion. Pigmented inks are used because of their color-fastness, thermal stability, edge definition, and low diffusivity on the printed substrate.

It is clear that the pigmented ink sets according to the fourth independent aspect of the invention may relate to the pigmented ink in any of the above independent aspects, with the pigmented ink sets optionally having characteristics from one or more of the above embodiments, without this being required.

It is noted that the use of high viscosity ink for the manufacture of decorative panels can form an inventive aspect which is independent from the use of a sheet in the manufacturing of said panel. For example, said high viscosity ink be printed directly into a substrate forming the substrate of the panel, wherein with “printed directly” it is intended that the printing operation can be performed on the substrate without the need of intermediate print carrier like the sheet of the previous independent aspect. Therefore, the expression “printed directly” doesn't exclude that one or more intermediate layer are provided on the surface of the substrate before printing like, for example, an ink receiver layer. Thereto according to its fifth independent aspect the invention relates to a method for manufacturing a decorative panel of the type comprising a plate shaped substrate and a top layer comprising a printed motif, wherein the method comprises the step of providing the plate shaped substrate and the step of forming the top layer on said plate shaped substrate wherein said step of forming the top layer at least comprising applying a printed motif directly onto said plate shaped substrate by means of digital printing, wherein the printed motif is applied using a pigmented ink. With the characteristic that the pigmented ink has a viscosity above 30 mPas, preferably above 40 mPas. Within the context of the present invention, for the viscosity it is meant the dynamic viscosity in a viscosimeter, preferably a dynamic viscosimeter, measured at 32° C. with a shear rate of 1000 s−1. It is noted that the ink and the decorative panel can comprise one or more of the features discussed above in reference to the first and third independent aspect, with particular references to the features of the ink, of the ink receiver layer, of the printing operation, of the substrate and of the wear layer.

### BRIEF DESCRIPTION OF THE DRAWINGS

With the intention of better showing the characteristics according to the invention, in the following, as an example without limitative character, some embodiments are described, with reference to the accompanying drawings, wherein:

FIG. 1 schematically shows an embodiment of a decorative sheet in accordance with the second aspect of the invention;

FIG. 2 shows some steps in a method in accordance with the first aspect of the invention for manufacturing the decorative sheet of FIG. 1;

FIG. 3 shows some steps in a method for manufacturing a decorative panel in accordance with the invention;

FIG. 4 shows in perspective a decorative panel obtained by means of the method of FIG. 3; and

FIG. 5 shows a view according to the line V-V indicated on FIG. 4.

### DESCRIPTION OF NON-LIMITING EMBODIMENTS

FIG. 1 schematically illustrates a decorative sheet 1 which, in the example, comprises a paper layer 2 provided with a printed motif 4 applied by a digital inkjet printer. According to the displayed embodiment, there is no ink receiver coating between the paper layer 2 and the printed motif 4, however, according to alternative embodiments there may be at least one ink receiver coating between the paper layer 2 and the printed motif 4. The paper layer 2 is, in this case, a base printing paper having a weight of about 70 grams per square meter and with a mean air resistance as expressed by the Gurley value of below 30 seconds.

It is generally noted that the dimensions of the displayed embodiments in the figures are drawn out of scale in order to better illustrate the invention. It is further understood that, while the displayed embodiments are for decorative paper layers, they can be equally applied, with minor adaptations within the ambit of a person skilled in the art, to other types of sheets, such as thermoplastic foils.

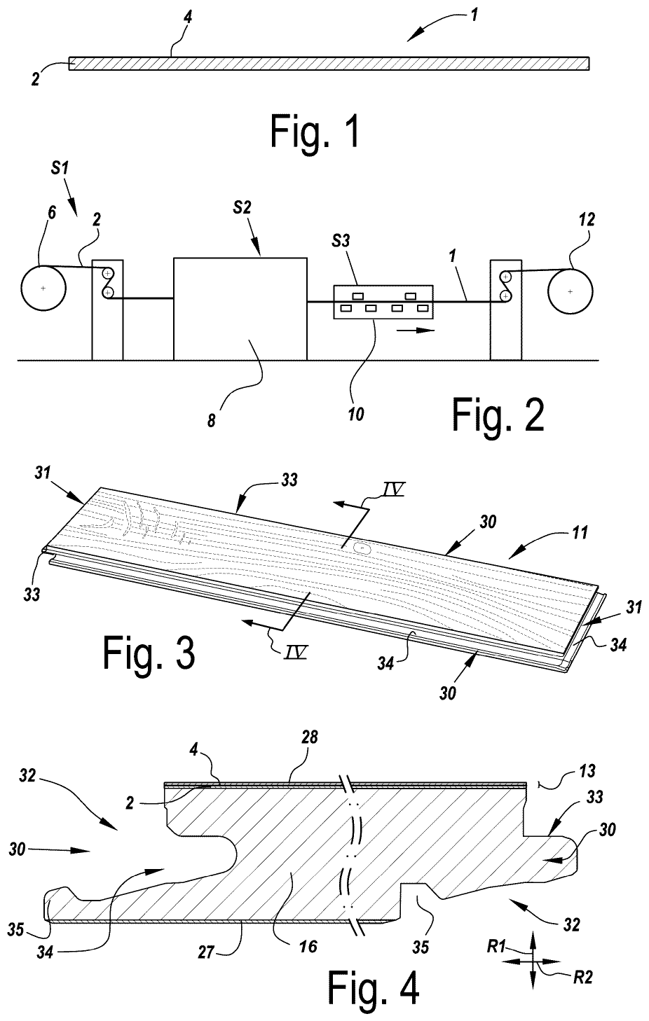

FIG. 2 shows some steps in a method for manufacturing the decorative sheet 1 of FIG. 1, according to the first independent aspect of the invention. The method of the example comprises the step S1 of providing the base paper layer 2 by uncoiling it from a first roll 6 to a digital printer 8 for performing a step S2 of printing the printed motif 4 on top of the paper layer 2. In the example, the inkjet printer 8 is a single-pass printer configured to eject droplets of pigment containing inks on the paper layer 2.

Said inks comprise at least four inks selected from the group formed by; cyan, yellow, red, magenta, and black. The inkjet printer 8 is configured to print a dry amount of pigment in the printed motif 4 of below 5 g/m2, preferably even below 2 g/m2. The inks are water-based and have a viscosity above 40 mPas. For example the inks have a solid portion being at least the 10% weight of the ink itself.

The method illustrated in FIG. 2 comprises the step S3 of drying the printed paper thereby obtaining the decorative sheet 1 preferably having the same characteristic of those at the beginning of the first independent aspect of the invention. In the example infrared lamps 10 are used, but alternatively other heating equipment can be used, such as microwave equipment or hot air oven. The decorative sheet 1 is then rolled up in a second roll 12. It is additionally to be noted that in the drawings the infrared lamps 10 are illustrate as a separate device downstream the printer 8, nevertheless it is possible that the infrared lamps 10 are also integrated in the printer 8 and that the drying operation can be performed substantially simultaneously and/or immediately after the printing operation.

In case an ink receiver layer has to be provided on the paper layer 2 it is possible that the method comprises a not illustrated coating step between steps S1 and S2.

FIGS. 3 and 4 illustrate a decorative panel 11 comprising a substrate 16 and a top layer 13, wherein the top layer 13 comprises the decorative sheet 1. In the example, the substrate 16 is made of a wood-based material, like for example HDF or MDF. The top layer 13 additionally comprises a wear layer 28 in the form of a thermosetting resin impregnated overlay paper.

The decorative panel 11 has the shape of a rectangular and oblong laminate floor panel, with a pair of long sides 30 and a pair of short sides 31. In this example, the decorative panel 11 is provided along the long sides 30 and short sides 31 with coupling means 32 allowing to lock the respective sides 30 and 31 together with the sides of a similar panel both in a direction R1 perpendicular to the plane of the coupled panels, as in a direction R2 perpendicular to the coupled sides and in the plane of the coupled panels.

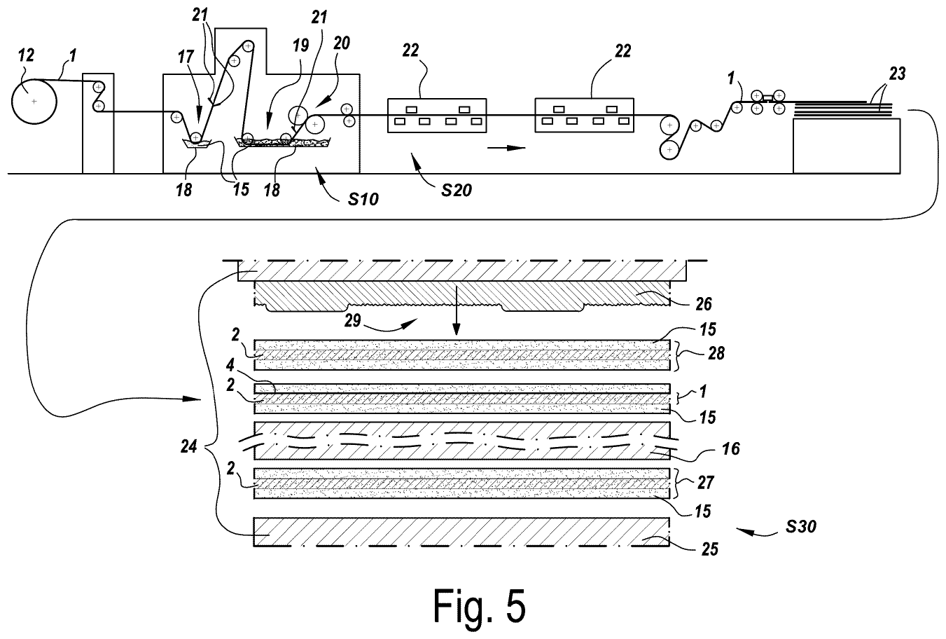

FIG. 5 illustrates a method for manufacturing the decorative panels 11 shown in FIGS. 3 and 4. The method of the shown embodiment comprises at least the step S10 of providing the decorative sheet 1 with a thermosetting resin 15. Hereto the decorative sheet 1 is taken from the second roll 12 of FIG. 2 and transported to a first impregnation station 17 where said decorative sheet 1 is immersed in a bath 18 of said resin 15, more particularly a mixture of water and resin 15. The decorative sheet 1 is then allowed to rest while in this case being transported upwards. The resting allows for the resin 15 to penetrate the core of the paper layer 2. The decorative sheet 1 then comes into a second impregnation station 19 where the decorative sheet 1 is, in this case, again immersed in another bath 18 of resin 15, more particularly a mixture of water and resin 15. A set of squeezing rollers 20 allows to dose the amount of resin 15 applied to the decorative sheet 1. In the example, several doctor blades 21 are available for partially removing resin at the surface of the resin provided decorative sheet 1.

In a second step S20 the resin provided decorative sheet 1 is dried and its residual humidity level is brought to below 10%. In the example hot air ovens 22 are used, but alternatively other heating equipment can be used, such as microwave drying equipment.

FIG. 5 also illustrates that the continuous, resin provided decorative sheet 1 is cut to individual sheets 23 and stacked.

FIG. 5 further illustrates that in a subsequent step S30 the obtained individual sheets 23 of the decorative sheet 1 is taken up in a stack to be pressed in a short daylight press 24 between upper and lower press plates 26, 25. Said stack comprises from bottom to top a counter layer 27, a plate-shaped substrate 16, the abovementioned decorative sheet 1 and the wear layer 28, wherein the counter layer 27 and the wear layer 28 both comprise a paper sheet 2 and resin 15. The stack is then pressed and the press treatment results in a mutual connection between the constituent layers 1-16-27-28 of the stack, as well as in a hardening or curing of the available resin 15. More particularly, here, a polycondensation reaction of the melamine formaldehyde resin 15 takes place, having water as a by-product.

The upper press plate 26 is a structured press plate that provides a relief in the melamine surface of the decorative panel 11 during the same press treatment of the step S30, by bringing the structured surface 29 of the upper press plate 26 into contact with the melamine of the wear layer 28.

The present invention is in no way limited to the above described embodiments, but such method may be realized according to different variants without leaving the scope of the present invention.

As is clear from the content of the description, the present invention relates to one or more of the items as listed below:
1.—Method for printing a decorative sheet for making decorative panels, comprising at least the steps of
   providing a sheet (2), preferably a paper layer or a foil,
   applying a printed motif (4) to the sheet by means of digital printing,
wherein the printed motif (4) is applied using a pigmented ink,
wherein the pigmented ink has a viscosity above 30 mPas, preferably above 40 mPas.
2.—Method for printing a decorative sheet for making decorative panels according to item 1, wherein the pigmented ink is water-based or aqueous.
3.—Method for printing a decorative sheet for making decorative panels according to item 1 or 2, wherein said inks comprise a solid portion and a fluid portion and wherein the solid portion represents at least the 10% weight of the ink itself, preferably above 15% weight.
4.—Method for printing a decorative sheet for making decorative panels according to any of the preceding items, wherein the sheet (2) comprises an ink receiver layer, wherein the ink receiver layer has a laydown of less than 30 g/m2, preferably less than 20 g/m2, more preferably less than 15 g/m2, and most preferably less than 10 g/m2.
5.—Method for printing a decorative sheet for making decorative panels according to any of the preceding items 1 to 3, wherein the sheet (2) is free of an ink receiver layer.
6.—Method for printing a decorative sheet for making decorative panels according to any of the preceding items, wherein the pigmented ink has a viscosity below 150 mPas, preferably below 100 mPas at 20° C.
7.—Method for printing a decorative sheet for making decorative panels according to any of the preceding items, wherein the sheet (2) is a paper layer with a Gurley value below 30 seconds, measured according to Tappi 460.
8.—Method for printing a decorative sheet for making decorative panels according to any of the preceding items, wherein the sheet (2) is a paper layer having a base weight of 50 to 100 grams per square meter, e.g. between 60 and 80 grams per square meter.
9.—Method for printing a decorative sheet for making decorative panels according to any of the preceding items 1 to 6, wherein the sheet (2) is a thermoplastic foil comprising thermoplastic material, wherein the thermoplastic material is preferably chosen from the list of polyvinyl chloride (PVC), polyethylene (PE), polypropylene (PP), polyethylene terephthalate (PET), thermoplastic polyurethane (TPU), polyvinyl butyral (PVB).
10—Method for printing a decorative sheet for making decorative panels according to item 9, wherein the thermoplastic material comprises fillers.
11.—Method for printing a decorative sheet for making decorative panels according to item 10, wherein the fillers comprise organic fillers, such as wood fibers or wood chips.
12.—Method for printing a decorative sheet for making decorative panels according to any of items 10 or 11, wherein the fillers comprise inorganic fillers, such as chalk, limestone or other CaCO₃ fillers.
13.—Method for printing a decorative sheet for making decorative panels according to any of items 9 to 12, wherein the thermoplastic material comprises foamed thermoplastic material.
14.—Method for printing a decorative sheet for making decorative panels according to any of items 9 to 13, wherein the thermoplastic material comprises plasticizer, preferably in an amount of less than 5 wt %.
15.—Method for printing a decorative sheet for making decorative panels according to any of the preceding items, wherein the dry weight of the deposited pigmented ink is less than 5 grams per square meter, preferably less than 2 grams per square meter.
16.—Method for printing a decorative sheet for making decorative panels according to any of the preceding items, wherein the total volume of deposited pigmented ink is less than 20 milliliters per square meter, preferably less than 15 milliliters per square meter, more preferably less than 10 milliliters per square meter.
17.—Method for printing a decorative sheet for making decorative panels according to any of the preceding items, wherein the drop size of the deposited pigmented ink is less than 50 picoliters, preferably less than 10 picoliters.
18.—Method for printing a decorative sheet for making decorative panels according to any of the preceding items, wherein the pigmented ink has a viscosity below 150 mPas, preferably below 100 mPas at 20° C.
19.—Method for printing a decorative sheet for making decorative panels according to any of the preceding items, wherein the pigmented ink is deposited using a digital inkjet printer.
20.—Method for printing a decorative sheet for making decorative panels according to item 19, wherein the digital inkjet printer is of the single-pass type or is operated in a single-pass mode.
21.—Method for manufacturing a decorative panel, comprising at least the steps of
providing a substrate material (12),
providing a decorative sheet (1) obtainable by the method of any of items 1-19 above the substrate material (12), and preferably directly above the substrate material (12),
connecting the substrate material (12) to the decorative sheet (1), preferably by means of lamination.
22.—Method for manufacturing a decorative panel according to item 21, wherein the decorative sheet (1) is a decorative paper layer, wherein the decorative paper layer (1) is impregnated with a thermosetting resin before lamination.
23.—Method for manufacturing a decorative panel according to item 22, wherein the decorative paper layer (1) is impregnated with an amount of thermosetting resin equaling 40 to 250% dry weight of resin as compared to the weight of the paper layer (2).
24.—Method for manufacturing a decorative panel according to item 25, wherein instead of providing a decorative sheet (1), the printed motif (4) is applied directly on the substrate material (12).
25.—Method for manufacturing a decorative panel according to any of items 21-24, wherein a relief is formed in the top layer (13) of the obtained decorative panel (11), wherein possibly the obtained relief reaches into the substrate material (12).
26.—Method for manufacturing a decorative panel according to any of items 21-25, wherein the decorative panel (11) is a floor panel, a wall panel, a ceiling panel, or a furniture panel.
27.—Decorative sheet obtained through any of the preceding items 1-20.
28.—Ink for use in decorative panels, wherein the ink is a pigmented ink, wherein the ink has a viscosity between 10 mPa·s and 150 mPa·s, preferably between 20 mPa·s and 100 mPa·s.
29.—Ink for use in decorative panels according to item 28, wherein the ink is water-based or aqueous.
30.—Ink for use in decorative panels according to any of items 28 29, wherein the ink has a viscosity above 30 mPa·s, preferably above 40 mPa·s.
31.—Ink for use in decorative panels according to any of items 28 to 30, wherein the pigmented ink comprises between 3 and 6 or even up to 8 different colors.
32.—Ink for use in decorative panels according to any of items 28 to 31, wherein the average particle size of the pigments in the pigmented ink are between 50 and 300 nm, preferably between 80 and 200 nm, more preferably between 100 and 150 nm.
33.—Ink for use in decorative panels according to any of items 28 to 32, wherein the pigmented ink comprises a dispersant, preferably a polymeric dispersant.

1. A method for printing a decorative sheet for making decorative panels, the method comprising:
providing a sheet;
applying a printed motif to the sheet by means of digital printing;
wherein the printed motif is applied using a pigmented ink; and
wherein the pigmented ink has a viscosity above 30 mPas.

2. The method for printing a decorative sheet for making decorative panels according to claim 1, wherein the pigmented ink is water-based or aqueous.

3. The method for printing a decorative sheet for making decorative panels according to claim 1, wherein the ink comprises a solid portion and a fluid portion; and
wherein the solid portion represents at least 10% weight of the ink itself.

4. The method for printing a decorative sheet for making decorative panels according to claim 1, wherein the sheet comprises an ink receiver layer;
wherein the ink receiver layer has a laydown of less than 30 g/m2.

5. The method for printing a decorative sheet for making decorative panels according to claim 1, wherein the sheet is free of an ink receiver layer.

6. The method for printing a decorative sheet for making decorative panels according to claim 1, wherein the pigmented ink has a viscosity below 150 mPas at 20° C.

7. The method for printing a decorative sheet for making decorative panels according to claim 1, wherein the sheet is a paper layer with a Gurley value below 30 seconds, measured according to Tappi 460.

8. The method for printing a decorative sheet for making decorative panels according to claim 1, wherein the sheet is a paper layer having a base weight of 50 to 100 grams per square meter.

9. The method for printing a decorative sheet for making decorative panels according to claim 1, wherein the sheet is a thermoplastic foil comprising thermoplastic material;
wherein the thermoplastic material is preferably chosen from the group of polyvinyl chloride (PVC), polyethylene (PE), polypropylene (PP), polyethylene terephthalate (PET), thermoplastic polyurethane (TPU), and polyvinyl butyral (PVB).

10. The method for printing a decorative sheet for making decorative panels according to claim 9, wherein the thermoplastic material comprises fillers.

11. The method for printing a decorative sheet for making decorative panels according to claim 10, wherein the fillers comprise organic fillers.

12. The method for printing a decorative sheet for making decorative panels according to claim 10, wherein the fillers comprise inorganic fillers.

13. The method for printing a decorative sheet for making decorative panels according to claim 9, wherein the thermoplastic material comprises foamed thermoplastic material.

14. The method for printing a decorative sheet for making decorative panels according to claim 9, wherein the thermoplastic material comprises plasticizer.

15. The method for printing a decorative sheet for making decorative panels according to claim 1, wherein a dry weight of the deposited pigmented ink is less than 5 grams per square meter.

16. The method for printing a decorative sheet for making decorative panels according to claim 1, wherein a total volume of deposited pigmented ink is less than 20 milliliters per square meter.

17. The method for printing a decorative sheet for making decorative panels according to claim 1, wherein a drop size of the deposited pigmented ink is less than 50 picoliters.

18. The method for printing a decorative sheet for making decorative panels according to claim 1, wherein the pigmented ink has a viscosity below 100 mPas at 20° C.

19. The method for printing a decorative sheet for making decorative panels according to claim 1, wherein the pigmented ink is deposited using a digital inkjet printer.

20. The method for printing a decorative sheet for making decorative panels according to claim 19, wherein the digital inkjet printer is of the single-pass type or is operated in a single-pass mode.
